(19) United States
(12) Patent Application Publication
(10) Pub. No.: US 2011/0224730 A1
(43) Pub. Date: Sep. 15, 2011

(54) Pacifiers

(76) Inventor: Dawn Holley, Boulder Creek, CA (US)

(21) Appl. No.: 12/661,207

(22) Filed: Mar. 11, 2010

(51) Int. Cl. A61J 17/00

(52) U.S. Cl. 606/236

(57) ABSTRACT

A pacifier includes a generally spherically or hemispherical, pliant, breast-like body having a center portion, the body comprised of a soft fabric stuffed with a light-weight stuffing material. The pacifier further includes a nipple. The body incorporates a feature for removably attaching the nipple to the body at the center portion of the body. In one configuration the nipple includes a nipple body and a base. The body includes a nipple support panel sewn to the soft fabric. The soft fabric includes an aperture in the center portion. The aperture is sized such that it can be distorted to accommodate insertion of the nipple base wherein the nipple base is retained between the soft fabric and the nipple support panel with the nipple body projecting through the aperture. A pacifier in the form of a blanket having a removable nipple is also described.

### BACKGROUND OF THE INVENTION

A. Field

This invention relates to improvements to pacifiers for infants and young babies.

B. Description of Related Art

A variety of pacifiers are described in the prior art. Prior art of interest includes Silverstein, U.S. Pat. No. 5,344,355; Schneider, U.S. Pat. No. 6,666,740; Demeritt et al., U.S. Pat. No. 5,534,014; Smith, U.S. patent publication 2008/0215092; Dunn et al., U.S. Pat. No. 6,292,962 and Xiques et al., U.S. Pat. No. 5,522,849.

### SUMMARY

In a first configuration, a pacifier is described which includes a generally spherical or hemispherical, pliant, breast-like body having a center portion, the body comprised of a soft fabric stuffed with a light-weight stuffing material. The pacifier further includes a nipple. The body incorporates a feature for removably attaching the nipple to the body at the center portion of the body, whereby the nipple can be removed for washing and reattached to the body for use.

The shape, size and configuration of the pacifier mimics the feel of the mother's breast, invoking feelings of security and comfort of breast-fed babies. When sized for an infant, it is easily held and allows the infant to find and latch to the nipple without assistance.

Preferably made with soft fabrics and stuffed with a light-weight soft filling such as siliconized fiber, it is light in weight and the pacifier provides a comforting pillow-like feel.

In a second configuration, a pacifier is disclosed in the form of a blanket and a nipple comprising a nipple body and a base. The pacifier further includes a feature for removably attaching the nipple to the blanket. In one embodiment, the blanket includes an aperture and a nipple support panel is sewn to the blanket proximate to the aperture. The aperture is sized such that it can be distorted to accommodate the nipple base wherein the nipple base is retained between the blanket and the nipple support panel with the nipple body projecting through the aperture. The nipple is thereby removable from the blanket for washing, and insertable into the blanket for use by means of the aperture. In a slight variation to this embodiment, the blanket further includes a nipple support panel that is sewn to the blanket. The nipple support panel includes the aperture. The aperture is sized such that it can be distorted to accommodate the nipple base wherein the nipple base is retained between the blanket and the nipple support panel with the nipple body projecting through the aperture. In this embodiment, the nipple is removable from the blanket for washing and insertable into the blanket for use.

These features for removable securing the nipple to the blanket can be used for securing the nipple to the body in the first embodiment.

### BRIEF DESCRIPTION OF THE DRAWINGS

Presently preferred embodiment are described below in conjunction with the appended drawing figures, wherein:

FIG. 1 is a top view of a first embodiment of a pacifier.

FIG. 2 is a bottom view of the first embodiment of FIG. 1.

FIG. 3 is a side view of the embodiment of FIGS. 1 and 2.

FIG. 3A is a cross-sectional view of the ear-like members of FIGS. 1-3.

FIG. 4 is a plan view of a nipple support panel which is sewn into the body of FIG. 1 to provide a feature for retaining the nipple to the pacifier.

FIG. 5 is a plan view of the pacifier of FIG. 1 with the nipple support panel sewn to the body and prior to insertion of the nipple into the aperture.

FIG. 6 is a perspective view of the nipple of FIG. 1 shown isolated.

FIG. 7 is a perspective view of second embodiment of a pacifier in the form of a blanket with a removable nipple.

FIG. 8 is an illustration of the blanket of FIG. 7 with the nipple removed and showing an aperture that is formed in the blanket during manufacture.

FIG. 9 is an illustration of a nipple support panel for the embodiment of FIG. 7.

FIG. 10 is a plan view of the blanket of FIG. 7 with the nipple support panel of FIG. 9 sewn to the panel.

FIG. 11 is a plan view of a nipple support panel having an aperture.

FIG. 12 is a plan view of a blanket having the nipple support panel of FIG. 11 sewn to it to provide a means for releasably retaining the nipple to the blanket.

### DETAILED DESCRIPTION

### A. First Embodiment

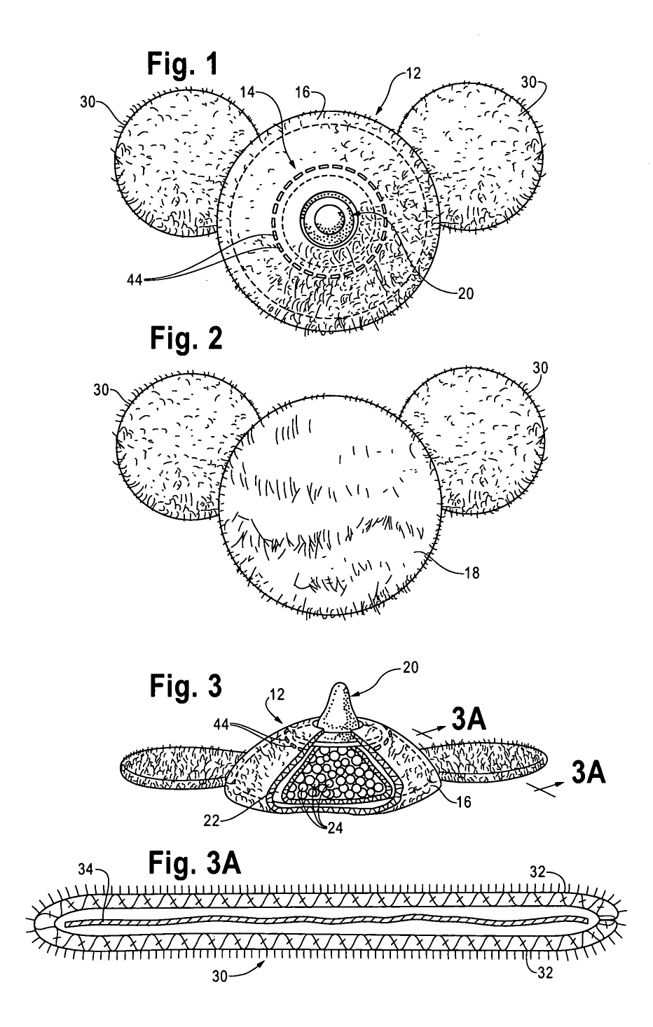

FIGS. 1, 2 and 3 are top, bottom and side views, respectively, of a pacifier 10 for a baby or infant in accordance with a first embodiment. The pacifier 10 includes a generally spherically or hemispherical, pliant, breast-like body 12 having a center portion 14. The body 12 is made from a washable, soft fabric material 16, such as cotton, fleece, or furry material. The body 12 is stuffed with a light-weight, non-allergenic, stuffing material such as fiber, pillow stuffing and polyethylene (PE) pellets.

In one configuration, the body includes comprises an inner pouch 22 (FIG. 3) located within the body 12 containing the light-weight stuffing material. In this embodiment, the stuffing material is in the form of PE pellets 24.

The pacifier 10 further includes a nipple 20, shown isolated in FIG. 6. The pacifier further includes a feature for removably attaching the nipple 20 to the body 12 at the center portion 14 of the body, whereby the nipple can be removed from the pacifier for washing and cleaning and then reinstalled onto the pacifier for use. Various designs of this feature are possible; several preferred designs will be discussed below.

Optionally, the pacifier further includes first and second generally flat, ear-like members 30 projecting from the body 12. In one possible configuration, the body 12 has a generally hemispherical, breast-like form having a base 18 (FIG. 2), and the first and second ear-like members 30 are attached where the base 18 is attached to the material 16 forming the hemispherical shape of the body 12. In one configuration, the ear-like members 30 have a furry-like surface. FIG. 3A shows in cross-section one possible construction for the ear-like members 30. The ear-like members 30 have upper and lower layers 32 made of a soft fabric such as furry material and a noise-producing material such as foil 34 sandwiched between the upper and lower layers 32, whereby the ear-like members 30 produce an audible crinkling like sound when gently manually manipulated, e.g., grasped by a baby using the pacifier. This feature provides further amusement and distraction for the baby.

The nipple 20 may be made from a silicone material. Preferably, the nipple 20 is a baby bottle-type nipple, ideally specifically designed for breast-fed babies. As shown in FIG. 6, the nipple 20 has a relatively flat broad base 26 and a nipple body 28 extending from the base 26. Alternatively, the nipple body 28 could take the form of pacifier nipple designs known in the art.

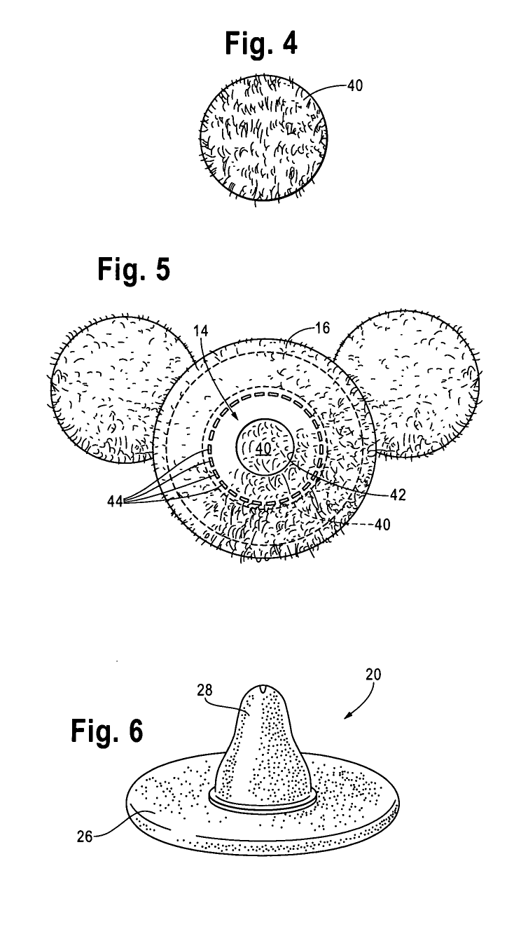

Methods for removably retaining the nipple 20 to the pacifier body 12 will now be described. In one configuration, and with reference to FIGS. 4, 5, and 6, a fabric nipple support panel 40 (FIG. 4) is incorporated into the pacifier 10 and is sewn to the fabric 16 below (on the back side of) the fabric 16, i.e., on the side of the fabric 16 facing the interior of the pacifier. Additionally, the fabric 16 is provided with an aperture 42 in the center portion 14, see FIG. 5. The nipple support panel 40 is sewn to the fabric 16 as shown in FIG. 5 as indicated by threads 44. The aperture 42 is sized such that it can be distorted (by pulling or stretching of the fabric 16) to accommodate insertion of the nipple base 26 through the aperture 42 wherein the nipple base 26 is retained behind the aperture 42, i.e., between the soft fabric material 16 and the nipple support panel 40, with the nipple body 28 projecting through the aperture 42, resulting in the configuration shown in FIGS. 1 and 3. To remove the nipple 20 from the pacifier, the users pulls or stretches the fabric 16 so that one edge of the nipple base 26 slides out of the aperture 42, and further manipulation of the nipple 20 and the fabric 16 results in extraction of the nipple from the pacifier. The nipple can now be washed or sanitized and then reinserted into the aperture for subsequent use by the infant. The aperture 42 is preferably sized relative to the diameter of the base of the nipple such that sufficient manual effort is needed to insert the base of the nipple into the aperture and remove the nipple from the aperture that it would not be possible for an infant to do this and thereby separate the nipple from the rest of pacifier.

In one variation of this approach, the fabric 16 is continuous (has no aperture) and the nipple support panel 40 is sewn to the fabric 16 from above, i.e., on the exterior of the fabric 16. The aperture 42 is formed in the nipple support panel. The aperture is sized such that it can be distorted to accommodate insertion of the nipple base. The nipple base is inserted into the aperture of the nipple support panel and is retained between the fabric 16 and the nipple support panel. This variation follows the description of FIGS. 11 and 12 discussed below.

Still further methods may be used for releasably attaching the nipple to the pacifier per prior art methods.

### B. Second Embodiment

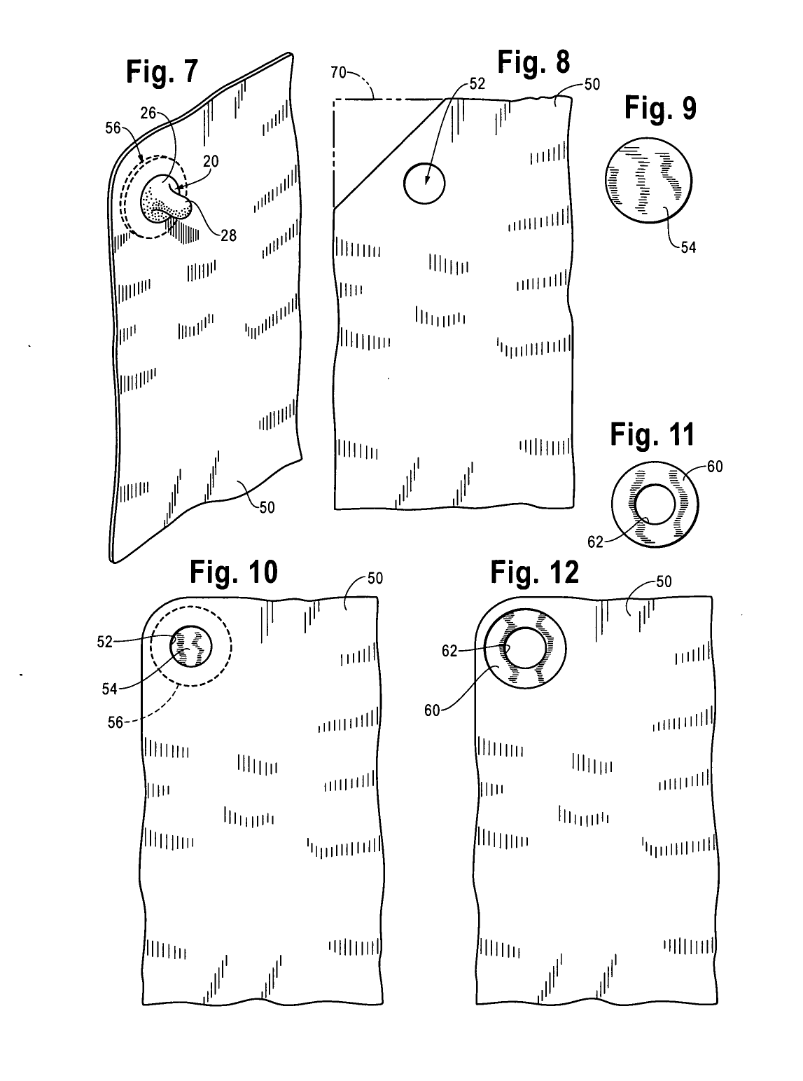

A second embodiment of my pacifier invention is shown in FIG. 7. This embodiment uses a blanket 50 and a nipple 20 having a nipple body 28 and a base 26. The nipple 20 takes the form of FIG. 6 and is as described previously. As shown in FIG. 8, the blanket includes an aperture 52. During manufacturing of the pacifier, a fabric nipple support panel 54 (FIG. 9) is sewn to the blanket 50 proximate to the aperture 52 (e.g., to the back side of the blanket), resulting in the construction of FIG. 10, with the stitching fastening the panel 54 to the blanket 50 indicated at 56. The aperture 52 is sized such that it can be distorted (e.g., by pulling or distorting the blanket 50 fabric) to accommodate the nipple base 26 wherein the nipple base is retained between the blanket 50 and the fabric nipple support panel 54 in the area surrounding the aperture 52 with the nipple body 28 projecting through the aperture as shown in FIG. 7. The nipple 20 is removable from the blanket 50 for washing and insertable into the blanket for subsequent use in the manner described previously.

The corner 70 of the blanket 50 closest to the pacifier (see FIG. 8) is preferably removed as indicated by dashed lines so that no fabric is encroaching the baby's nose during use.

A variation on this construction will be described in conjunction with FIGS. 11 and 12. In this variation, the blanket 50 does not include the aperture. Rather, a nipple support panel 60 having an aperture 62 (FIG. 11) is sewn directly to the blanket 50, resulting in the construction of FIG. 12. The aperture 62 is sized such that it can be distorted (e.g., by pulling or distorting the blanket 50 fabric) to allow for insertion of the nipple base 26 (FIG. 6) into the aperture 62, wherein the nipple base 26 is retained between the blanket 50 and the nipple support panel 60 in the area of the panel 60 surrounding the aperture 62. The nipple 20 is removable for cleaning and reinsertion into the blanket as described previously.

Top facilitate the distortion of the aperture 62, elastic material may be used as the nipple support panel 60. Similarly, in FIG. 8, an elastic material may be sewn to the blanket 50 which defines the aperture 52. Elastic material may also be used to define the aperture 42 in FIG. 5. The use of elastic material will allow the pacifier toy to adapt to different brands and sizes of pacifiers.

While preferred and alternative embodiments have been described with particularity, those skilled in the art will realized that departures for the specific details of the disclosed embodiments are of course possible. All questions concerning the scope of the invention are to be answered by reference to the appended claims.

I claim:

1. A pacifier, comprising:
a generally spherical or hemispherical, pliant, breast-like body having a center portion, the body comprised of a soft fabric stuffed with a light-weight stuffing material; and
a nipple;
wherein the body incorporates a feature for removably attaching the nipple to the body at the center portion of the body.

2. The pacifier of claim 1, wherein light-weight stuffing material comprises a fiber material.

3. The pacifier of claim 1, wherein the stuffed toy further comprises an inner pouch located within the body containing the light-weight stuffing material.

4. The pacifier of claim 3, wherein the light-weight stuffing material comprises pellets.

5. The pacifier of claim 1, wherein the body further comprises first and second generally flat, ear-like members projecting from the body.

6. The pacifier of claim 6, wherein the ear-like members have a furry-like surface.

7. The pacifier of claim 1, wherein the nipple is made from a silicone material.

7. The pacifier of claim 5, wherein the first and second ear-like members comprise upper and lower layers of a soft fabric and a noise-producing material sandwiched between the upper and lower layers, whereby the ear-like members produce an audible sound when gently manually manipulated.

8. The pacifier of claim 1, wherein nipple further comprises a nipple body and a base, and wherein the body further comprises a nipple support panel sewn to the soft fabric, the nipple support panel having an aperture, wherein the aperture is sized such that it can be distorted to accommodate insertion of the nipple base wherein the nipple base is retained between the soft fabric and the nipple support panel with the nipple body projecting through the aperture.

9. The pacifier of claim 1, wherein the wherein nipple further comprises a nipple body and a base, and wherein the soft fabric comprises an aperture, and wherein the stuffed toy further comprises a nipple support panel sewn behind the soft fabric proximate to the aperture, wherein the aperture is sized such that it can be distorted to accommodate the nipple base wherein the nipple base is retained between the soft fabric material adjacent to the aperture and the fabric nipple support with the nipple body projecting through the aperture.

10. A pacifier comprising:
a blanket, and
a nipple comprising a nipple body and a base,
wherein the blanket comprises an aperture and a nipple support panel sewn to the blanket proximate to the aperture, wherein the aperture is sized such that it can be distorted to accommodate the nipple base wherein the nipple base is retained between the blanket and the nipple support panel with the nipple body projecting through the aperture, the nipple thereby being removable from the blanket for washing and insertable into the blanket for use.

11. A pacifier, comprising
a blanket and a nipple comprising a nipple body and a base, the nipple detachable from the blanket,
wherein the blanket further comprises a nipple support panel sewn to the blanket, the nipple support panel having an aperture, wherein the aperture is sized such that it can be distorted to accommodate the nipple base wherein the nipple base is retained between the blanket and the nipple support panel with the nipple body projecting through the aperture; the nipple thereby being removable from the blanket for washing and insertable into the blanket for use.

12. The pacifier of claim 8, wherein the nipple support panel is made from an elastic material.

13. The pacifier of claim 10, wherein the blanket further comprises an elastic material forming the aperture.

14. The pacifier of claim 11, wherein the nipple support panel is made from an elastic material.
